(19) United States
(12) Patent Application Publication
(10) Pub. No.: US 2010/0187390 A1
(43) Pub. Date: Jul. 29, 2010

(54) Flushometer mounted drink holder

(76) Inventor: Clayton Robert Noyes, McHenry, IL (US)

Correspondence Address: Clayton Robert Noyes, 501 Whitmore Trail, McHenry, IL, 60050, US

(21) Appl. No.: 12/657,765

(22) Filed: Jan. 25, 2010

Related U.S. Application Data
(60) Provisional application No. 61/205,929, filed on Jan. 26, 2009.

(51) Int. Cl. F16M 13/00

(52) U.S. Cl. 248/222.14; 248/311.2

(57) ABSTRACT

A drink holder which is readily attached to a flushometer.

The following U.S. patent application is hereby incorporated by reference in its entirety for its teaching:

U.S. Provisional Patent Application Ser. No. 61/205,929 for Flushometer Mounted Drink Holder, filed Jan. 26, 2009.

### BACKGROUND OF THE INVENTION

1. Field of the Invention

This invention relates to drink holding devices. More specifically, the present invention relates to drink holding devices that may be readily attached to a flushometer plumbing fixture or the like.

2. Prior Art

Beverages contained within drinking containers comprising bottles, glasses, and cups are likely to be consumed in business establishments where restrooms are lacking a nearby location where drinks can be received and vertically stabilized, preventing them from slipping and crashing to the floor. While numerous drink holding devices have been provided with a specific purpose in the prior art, no known device is suitable for the purpose of the present invention.

The Willeby U.S. Pat. No. 4,560,128 shows a drink holder that attaches to vertical poles of chairs and similar furniture, with a hinged type bracket, without the use of any tools. My invention does not claim to attach to chairs or similar furniture nor does it use a removable hinged type bracket. My invention mounts rigidly to flushometer plumbing fixtures, or the like plumbing, using two screws along with a two piece bracket, only being removed with the proper tools.

The Ray U.S. Pat. No. 5,628,485 also shows a drink holder that attaches to a lawn chair or the like. Hook and loop material is used to fasten the clamp into place also allowing for a quick removable attachment. My invention does not claim to attach to lawn chairs, or the like, nor does it claim to be removed quickly. My invention mounts to flushometer plumbing fixtures, or the like plumbing, and is only removable with the proper tools.

The Manfre U.S. Pat. No. 5,007,612 shows a drink holder that attaches to handrails within a boat type watercraft. It is mounted with a screw type clamp, allowing for quick removal, and two concave radii. Again, my invention mounts to flushometer plumbing fixtures, or the like plumbing, and is intended to be removed only with the appropriate tools.

The Kayali U.S. Pat. No. 5,014,956 shows a drink holder that attaches to an available structure by means of suction cups, a spring type clamp, or a magnet. When not in use, it's capable of folding into a minimal amount of space within its frame. Mounting to a flushometer plumbing fixture, or similar plumbing, would be difficult with the use of suction cups, a spring type clamp, and a magnet. My invention mounts rigidly, using two screws along with a two piece bracket which provides clamping pressure to a flushometer plumbing fixture, or the like plumbing.

### SUMMARY OF THE INVENTION

This invention is directed to a drink holder that is rigidly attachable to a flushometer plumbing fixture or the like plumbing and can be installed quickly and easily with the appropriate tools.

The principle object of this invention is to give a secure and level location to rest beverage containers.

Another objective of this invention is for the drink holder to be manufactured of few parts, reducing the cost of production.

A further objective of this flushometer mounted drink holder is to provide the user with a safe location to rest their drink rather than leaving their drink unattended while they're away in the restroom. Another objective of this invention is to give a level area to place drinks, saving on the number of broken beverage containers and spilled drinks by preventing them from falling to the floor.

Another objective of this invention is for the drink holder to be constructed entirely of anti-corrosive material.

The drink holder of this invention is constructed basically of three separate parts, the first being the drink holder housing, the other two being a two piece mounting bracket. The housing includes an elongated open-sided slot. This slot is located in the front for the placement of mug handles and for the run off of condensation. Located in the base of the housing are four holes giving the two mounting screws a point at which they pass through to the bracket. Each piece of the two piece bracket has a concave radius, sized for a close fit around the mounting pipe. The bracket is placed under the housing. One piece of the bracket is placed above the mounting pipe, the other is placed underneath. The two screws are inserted from the housing downward to the threads located in the lower bracket piece.

To accomplish the above and related objects, this invention may be embodied in the form illustrated in the accompanying drawings, attention being called to the fact, however, that the drawings are illustrative only and that changes may be made in the specific construction illustrated and described within the scope of the appended claims.

While I have shown in the accompanying drawings, a preferred embodiment of my invention, it is to be understood that this invention is susceptible to modification and change without departing from the purpose of this invention.

### BRIEF DESCRIPTION OF THE DRAWINGS

FIG. 1 is a front elevation view of the preferred embodiment of the invention.

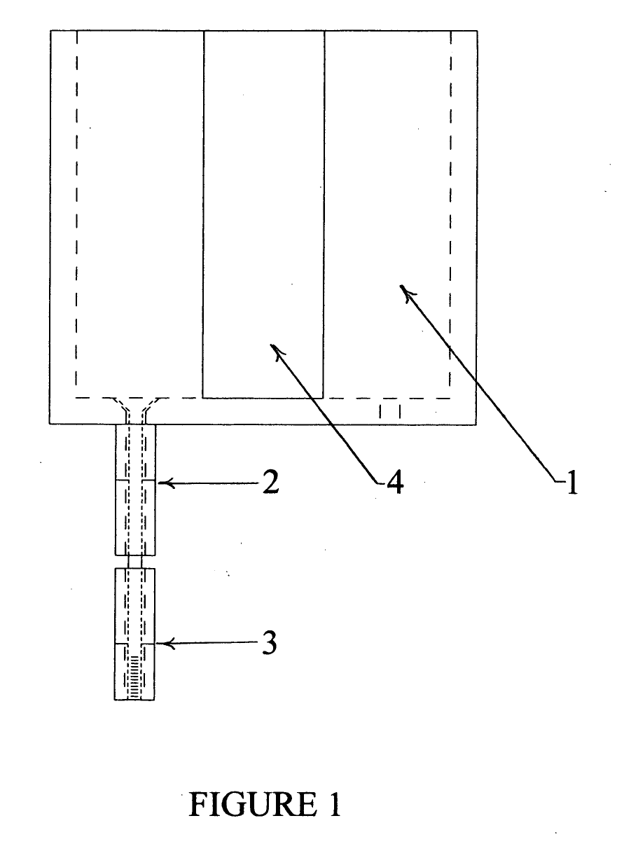

FIG. 2 is a left elevation view of the preferred embodiment of the invention.

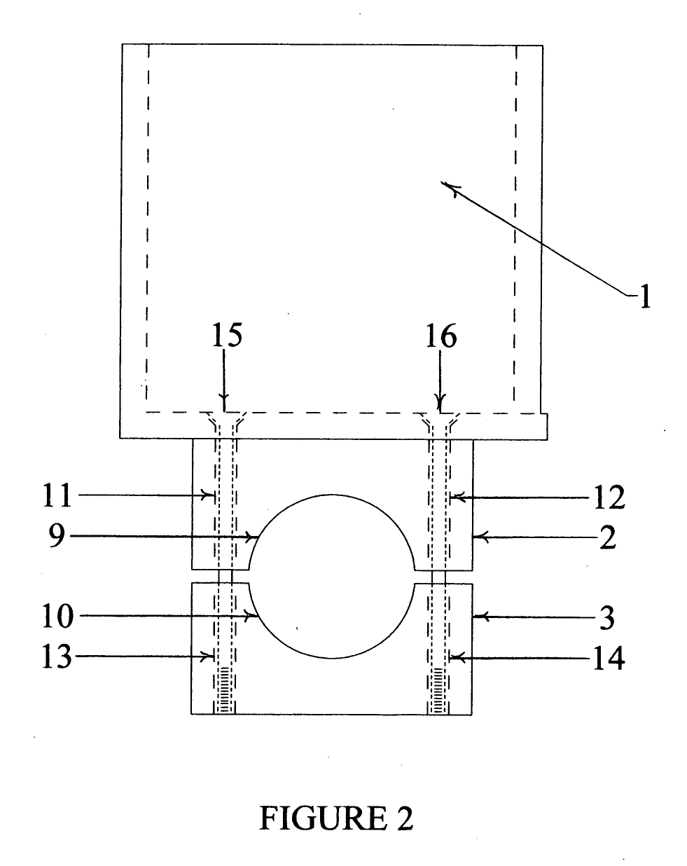

FIG. 3 is the top elevation view of the preferred embodiment of the invention.

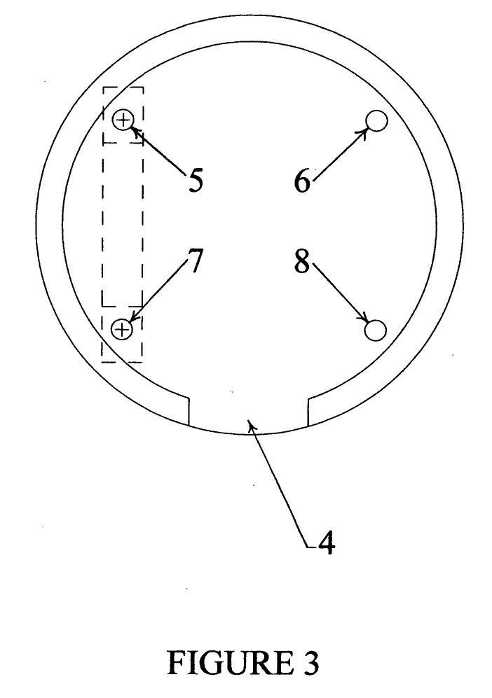

### DETAILED DESCRIPTION

The drink holder of this invention is constructed basically of three separate parts, the first being the drink holder housing 1, the other two being a two piece mounting bracket, having first and second clamping members 2 and 3. The housing 1 is large enough to receive containers comprising cups, glasses, mugs, and bottles. The housing 1 includes an elongated open-sided slot 4 in the front of the housing. This slot 4 is for the placement of mug handles and to allow the run off of condensation from cold drinks. The housing 1 mounts above the top bracket section 2. Bracket section 2 has a concave radius or recess, 9, on one side and a flat surface on the other side. Bracket section 3 also has a concave radius or recess, 10, on one side and a flat surface on the other side. These concave radii or recesses, 9 and 10, are sized for a tight fit, opposite one another, on the mounting pipe. The bracket sections 2 and 3 are placed under the housing, 2 being placed above the mounting pipe, while 3 is placed below the mounting pipe.

Located in the base of the housing 1 are four holes, 5, 6, 7, and 8, giving two mounting screws, 15 and 16, a point at which they pass through the housing to the brackets. Only two screws will be needed for each installation, however having four holes allows for the housing to mounted facing in different directions. These holes also allow the drink holder the versatility of being installed with the flushometer water supply being on the right or the left while preventing contact with the flushometer diaphragm housing.

Bracket section 2 has two holes, 11 and 12. Bracket 3 has two threaded holes, 13 and 14. These four holes accommodate the two mounting screws 15 and 16. These two screws, when tightened, pull the two bracket sections 2 and 3 towards one another, affixing the bracket sections along with the housing, rigidly to the mounting pipe.

When this lightweight drink holder is rigidly fastened in position, it gives the user a strong and level platform that will not move when a drink is placed within it. It also, does not obstruct the operation of the flushometer in any way nor does it prevent a plumber's access to the flushometers water shut off valve or the diaphragm assembly if service should ever be needed.

This drink holder can be manufactured in a variety of ways and materials. One of these processes is with an injection mold using materials comprising plastic. It is believed that this would be the most economical and affordable for the purchaser. This would also give the manufacturer the ability to produce this item in a variety of colors. This holder could also be die cast using materials comprising aluminum. Sand casting could be another method by which these parts could be made, using materials comprising aluminum or brass. While making these parts out of metal may be more expensive, it may hold up to vandalism better than plastic. Producing them of aluminum or brass would also allow the option of chrome plating. They could even be machined from solid stock in from materials comprising plastic, aluminum, or brass. The presently preferred embodiment was fabricated from aluminum stock.

The drink holding devise of this invention is economical to construct and readily install. While certain novel features of this invention have been shown and described and are pointed out in the annexed claims, it will be understood that various omissions, substitutions, and changes in the forms and details of the devise illustrated and in its operation can be made by those skilled in the art without departing from the spirit of this invention.

I claim:

1. An apparatus for holding a beverage container, comprising:
a housing;
a bracket, fastening to the mounting surface by means of friction and connected to the housing comprising screws

2. The apparatus of claim 1, wherein the housing is of adequate size such that containers comprising cups, mugs, glasses, and cans can be located within the confines and held vertically.

3. The apparatus of claim 1, wherein the housing includes an elongated open-sided slot to accommodate the handles of mug containers.

4. The apparatus of claim 1, wherein the housing includes an elongated slot extending to the base of the housing, to relieve the housing of condensation.

5. The apparatus of claim 1, wherein the housing includes four holes for the versatility of being mounted with the bracket on either side of a flushometer.

6. The apparatus of claim 5, wherein the housing includes four holes for the versatility of being mounted with the bracket facing different directions.

7. The apparatus of claim 1, wherein the bracket includes two pieces each having a radius substantially equal to the radius of mounting surface of the flushometer or the like plumbing, and two screws for drawing the two pieces together.

8. The apparatus of claim 1, wherein the bracket includes two holes through which two screws pass from the housing to the bracket sections, where the screws tighten the bracket sections against the flushometer or plumbing pipe.

9. A drink holder for use with a flushometer comprising:
a drink holder having a sidewall and base, said base having four holes formed therein,
each of the said clamping members having a concave recess on a first side and a flat surface on the opposite side, each of the said clamping members having two holes formed therein, with threads being provided in the holes of said one of the clamping members,
a pair of screws, each of said pair of screws passing through one hole in said housing base, and one of said holes in each of said clamping members, whereby with a pipe being located in said concave recesses of said clamping members, and said first one of the said clamping members being located next to said base of said drink holder, said screws engaging the threaded holes in said second one of said clamping members to clamp said drink holder to the plumbing.
